(19) United States
(12) Patent Application Publication
(10) Pub. No.: US 2006/0261002 A1
(43) Pub. Date: Nov. 23, 2006

(54) Filter element

(75) Inventors: Klemens Dworatzek, Edingen (DE); Ralf Bauder, Ketsch (DE); Karlheinz Muenkel, Oberderdingen-Flehingen (DE); Udo Wagner, Marklkofen (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/435,790

(22) Filed: May 18, 2006

(30) Foreign Application Priority Data
May 19, 2005 (DE) 20 2005 008 092.6

(51) Int. Cl. B01D 29/07; B01D 46/00

(52) U.S. Cl. 210/493.1; 55/490; 210/497.01; 55/521

(57) ABSTRACT

A filter suitable for use, for example, as an air filter for filtering the combustion air for internal combustion engines, having a substantially hollow cylindrical filter insert, preferably made of a pleated or fan folded filter medium, and end disks disposed at the axial end faces. A plurality of spacing contours distributed around the circumference and protruding radially beyond the projected end face are disposed in the region of one end disk in such a way that the spacing contours contact an inner housing wall of an associated filter housing when the filter insert is installed.

### BACKGROUND OF THE INVENTION

The present invention relates to a filter, particularly an air filter, preferably for filtering the combustion air for internal combustion engines, comprising a hollow cylindrical filter medium with end disks on each of its axial end faces.

U.S. Pat. No. 5,660,729 (=DE 44 16 577) discloses a filter insert for a filter for filtering liquid or gaseous media. This filter insert has a substantially hollow cylindrical filter body, through which the medium to be filtered flows in radial direction, and two end disks at its respective end faces. One of the end disks is provided with a central opening and can be axially placed onto a media inlet or outlet fitting so as to form a radial seal. The opposite end disk is closed, and the end disks are made of a thermally recyclable plastic. The closed end disk further has a latching recess adapted to receive latching counter elements of a screw cap of an associated filter housing or a removal tool. This latching recess is necessary to prevent vibrations that occur during operation of the internal combustion engine from causing the end opposite the outflow or inflow line to oscillate. Radial oscillations of the free end of the filter element within the housing would cause either leaks in the region of the opposite radial seal or wear-through of the free end of the filter element at the housing wall. In the course of such wear the filter medium could also wear through and cause leaks between the unfiltered and the filtered side.

Other prior art solutions to this problem include axial supports via the end disk on the cap or radial supports on the inside of the media bellows. The drawback of the first variant is the high price and the loading of the cap. The drawback of the second variant is that it requires an element that is open on the inside.

### SUMMARY OF THE INVENTION

Accordingly, it is an object of the present invention to provide an improved filter element which is resistant to damage from vibration of a system in which it is installed.

Another object of the invention is to provide a filter element which has a simple and cost-effective construction.

A further object of the invention is to provide a filter element which prevents an oscillation of the filter element when vibrations occur.

These and other objects are achieved in accordance with the present invention by providing an air filter comprising a substantially hollow cylindrical filter insert made of a filter medium with end disks disposed on the axial end faces, in which a plurality of spacing contours are disposed adjacent one end disk distributed around the circumference of the one end disk and protruding radially outwardly beyond the end face of the one end disk such that when the filter insert is installed in a filter housing, the spacing contours will contact an inside housing wall of the filter housing.

The invention thus relates to a filter for liquid or gaseous media, particularly an air filter, preferably for filtering the combustion air of internal combustion engines. The filter comprises a substantially hollow cylindrical filter insert, particularly made of a fan folded filter medium. The filter medium is preferably filter paper. It is also possible, however, to use a synthetic medium or a wound nonwoven material. End disks are disposed at the end faces of the hollow cylindrical filter element. A plurality of spacing contours, which are distributed over the circumference and radially protrude over the projected end face, are disposed in the region of one end disk. These spacing contours may, for example, take the form of lugs, pins or segments of a circle. When the filter insert is installed, the spacing contours contact an inner housing wall of the associated filter housing. This advantageously prevents any oscillation of the free end of the filter within the housing but does not require any special technical or structural means to be provided on the housing. The distance between the inner housing wall and the filter medium can still be defined via the depth of the spacing contours extending beyond the projected plane. A further price advantage is obtained by disposing the spacing contours not continuously around the entire filter element but distributed over the circumference, which results in additional material cost savings.

According to one advantageous embodiment of the invention, a support member is disposed on the inner wall and/or the outer wall of the filter medium. This support member serves to absorb the substantially radially inwardly or outwardly acting forces during the flow of the medium through the filter body. The support member is preferably designed as a hollow cylindrical grid since this offers a good ratio between the support action on the one hand and the consumption of material and space on the other. The support member is preferably made of synthetic resin material (i.e., plastic).

According to another advantageous embodiment of the invention, the end disk is closed in the region of the spacing contours, and the opposite end disk has an inner radially sealing seat. Especially in this configuration, the end of the filter element having the closed end disk must be fixed relative to the housing interior to prevent oscillation and thus wear-through of the filter medium. The spacing contours in the region of the closed end disk fix the filter element within the housing, such that a predefined distance is established between the filter housing and the filter medium.

It is advantageous to fix the spacing contours directly to the end disk or form them integrally therewith. The spacing contours, e.g., in the form of lugs or segments, may be bonded, welded, injection-molded, clipped or in some other way releasably or non-releasably affixed to the end disk, or produced directly together with the end disk in the original forming process. The end disk may, for example, be produced together with the spacing contours, which are distributed along the circumference, directly in the injection molding or casting process.

According to yet another advantageous embodiment of the invention, the end disk with the spacing contours is produced from an injection-moldable synthetic resin material. Examples of suitable materials include polyamide and polypropylene. The end disk with the spacing contours may represent the actual, functional end disk, i.e., it may assume the role of closing and sealing the filter medium, or it may in addition be releasably or non-releasably attached to the functional end disk.

As an alternative, the end disk with the spacing contours may be made of a thermoplastic elastomer or nitrile rubber. Thermoplastic elastomers are materials in which elastomer phases as the soft component are integrated into plastics as the hard component. Thermoplastic elastomers or TPE for short, unlike elastomers, are not chemically irreversibly but physically reversibly cross-linked. The reversible cross-linking is produced by their two-phase construction. With a suitable molecular architecture, the domains of the hard sequences form the physical cross-linking points in a continuous matrix of the soft sequences, which are selected such that their service temperature is above their glass transition temperature (second order transition temperature). In contrast, the glass transition temperature (if amorphous) or the melting temperature (if partly crystalline) of the hard sequences must be above the service temperature, so that the domains of the hard sequences can act as cross linking points. At their service temperatures TPEs behave like elastomers, but above the characteristic transition temperature the hard sequences become mobile and the TPEs can be processed like thermoplastics. The great advantage of TPEs compared to vulcanized elastomers is that they are substantially easier to process: mastication (oxidative degradation), incorporation of vulcanization accelerators, in some cases also compounding, and of course also vulcanization are eliminated.

According to yet another alternative embodiment of the invention, the end disk with the spacing contours is made of a thermoplastic polyurethane foam. Thermoplastic polyurethane foam may also be produced easily and non-releasably connected to the filter medium. The high elasticity of polyurethane foam makes it possible to substantially over-dimension the spacing contours relative to the inside diameter of the housing because the spacing contours are highly compressible and thus produce a very secure fixation within the housing.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings, in which:

FIG. 1 is a perspective view of a filter insert according to the invention, and

FIG. 2 is an enlarged detail view of a region of the filter insert of FIG. 1.

### DETAILED DESCRIPTION OF PREFERRED EMBODIMENTS

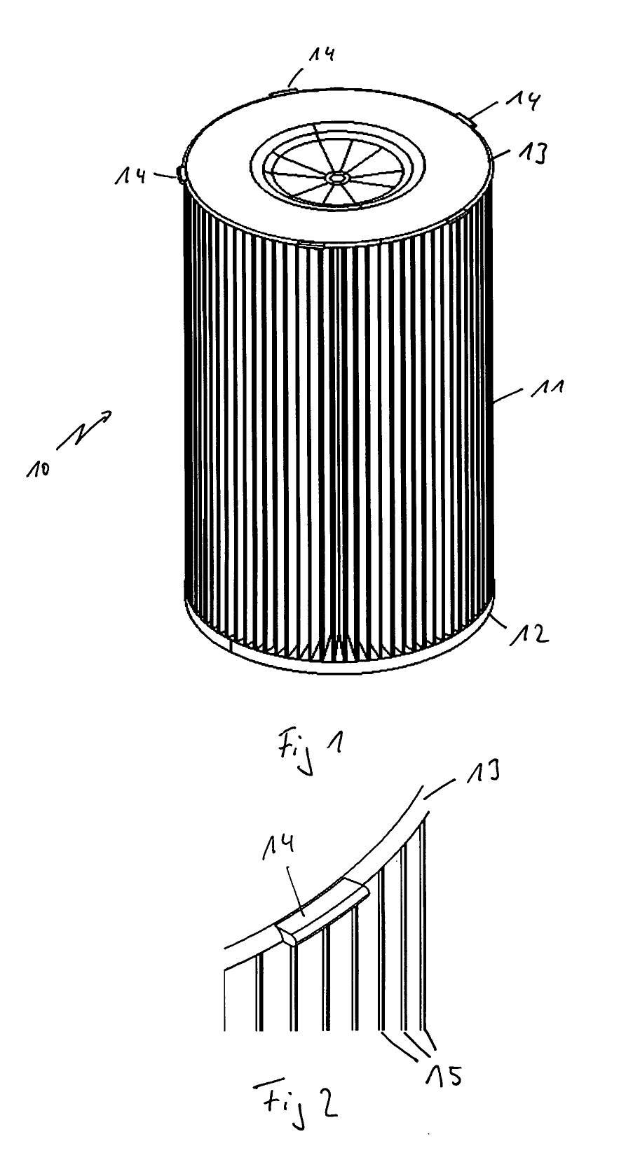

FIG. 1 is an isometric view of a filter 10 according to the invention. The filter 10 has a fan folded filter medium 11, which is closed at its one end face by a first end disk 12 and at the opposite end face by a second end disk 13. The first end disk 12 has an opening (not shown) in its interior with an inside sealing contour for receiving a connection fitting in the housing (not shown). The second end disk 13 is closed and has a plurality of spacing contours 14 distributed over its circumference. These spacing contours 14 extend radially beyond the projected end face of the filter 10 and are formed integrally directly with the second end disk 13.

FIG. 2 shows a detail in the region of the second end disk 13 of the filter 10. Components corresponding to those of the preceding figure are identified by the same reference numerals. It may be seen that the second end disk 13 delimits and seals the filter medium 11. The individual folds 15 of the filter medium 11 are visible in FIG. 2. This figure also shows that the spacing contour 14 has the shape of segments of a circle, which are distributed around the circumference of the second end disk 13.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A filter comprising a substantially hollow cylindrical filter insert made of a filter medium with end disks disposed on the axial end faces, wherein a plurality of spacing contours are disposed adjacent one end disk distributed around the circumference of said one end disk and protruding radially outwardly beyond the end face of said one end disk such that when the filter insert is installed in a filter housing, the spacing contours will contact an inside housing wall of the filter housing.

2. A filter according to claim 1, further comprising a support member is disposed on the inner wall or the outer wall of the filter medium.

3. A filter according to claim 1, wherein the end disk is closed adjacent the spacing contours is closed, and the opposite end disk comprises an inner radial sealing seat.

4. A filter according to claim 1, wherein the spacing contours are attached to the one end disk.

5. A filter according to claim 4, wherein the end disk with the spacing contours is made of an injection-moldable synthetic resin material.

6. A filter according to claim 4, wherein the end disk with the spacing contours is made of a thermoplastic elastomer or nitrile rubber.

7. A filter according to claim 4, wherein the end disk with the spacing contours is made of a thermoplastic polyurethane foam.

8. A filter according to claim 1, wherein the spacing contours are integrally formed with the one end disk.

9. A filter according to claim 8, wherein the end disk with the spacing contours is made of an injection-moldable synthetic resin material.

10. A filter according to claim 8, wherein the end disk with the spacing contours is made of a thermoplastic elastomer or nitrile rubber.

11. A filter according to claim 8, wherein the end disk with the spacing contours is made of a thermoplastic polyurethane foam.

12. A filter according to claim 1, wherein said filter is an air filter for filtering combustion air for an internal combustion engine.

13. A filter according to claim 1, wherein said filter medium is a pleated filter medium.
